(19) United States
(12) Patent Application Publication
(10) Pub. No.: US 2004/0087367 A1
(43) Pub. Date: May 6, 2004

(54) Real-time rules-based service management system for gaming activities

(76) Inventor: Robert J. Hendrickson, Bedminster, NJ (US)

Correspondence Address: KATTEN MUCHIN ZAVIS ROSENMAN, 575 MADISON AVENUE, NEW YORK, NY, 10022-2585, US

(21) Appl. No.: 10/285,372

(22) Filed: Oct. 31, 2002

(51) Int. Cl. G06F 17/00

(52) U.S. Cl. 463/42

(57) ABSTRACT

A system and method are disclosed for the real-time management and assignment of service providers to service gaming activities in a gaming environment. The system and method operate to assign service providers to high priority service events, where priority is determined as a function of predetermined business rules, and event qualification including at least one of a gaming activity identifier, a customer identifier, a service event type, a service event location and a service event open time for each service event. The system and method provide related means for evaluating and reporting an event status based on the predetermined rules and event qualification.

### FIELD OF THE INVENTION

The present invention relates to a system for the management and assignment of service providers that support gaming activities. More specifically, the system relates to a computer-assisted, rules-based system using real-time data collected from various sources for the management and assignment of service providers to service customers, automated gaming machines and other gaming activities.

### BACKGROUND OF THE INVENTION

Gaming activities, such as the use of slot machines, video lottery machines and gaming tables, are widely undertaken in casinos and other commercial gaming environments. Automated gaming machines, such as slot machines and video lottery machines, in particular provide the advantages of easy game playing for customers while generally requiring limited involvement from associated service providers.

Although required service provider support for automated gaming machines may be relatively limited, it is none-the-less important in the context of certain key service events. For example, service provider intervention may be required when a gaming machine fails to provide service (for example, in the event of a coin-in jam), when a customer has won a machine jackpot payout in excess of the current coin fill of the machine, and for a variety of other key service events associated with customer utilization of the machine and enjoyment of the associated gaming experience.

Clearly, effectively responding to service events associated with non-automated gaming activities is no less important (for example, providing important customers with direct payouts at gaming tables). In sum, in order to maintain desired levels of customer satisfaction, casinos must both respond quickly to a great variety of service events associated with a great variety of gaming activities, and must resolve or close such events quickly.

Customers may have varying expectations with regard to responsiveness of service. For example, customers who are frequent patrons of a casino and who spend significant sums of money on gaming and other activities at the casino may typically be expected to have higher expectations with regard to service responsiveness than customers who are more casual patrons. Casino operators have a vested interest in assuring that service quality expectations are met for high-spending patrons, and may accordingly assign such patrons to exclusive service distinction tiers or classes, which are targeted for expedited service and other service perquisites, on the basis of a patron's level of gaming activities. For example, U.S. Pat. No. 6,183,362 to Boushy discloses a system and method for tracking customers' gaming and non-gaming activities at a casino in order to administer customer recognition awards for active patrons, and is hereby incorporated by reference.

In order to quickly respond to service events, systems have been developed that enable impacted events to be recognized and reported in real-time (i.e., nearly coincident with the occurrence or change in status of the event) so that service providers may be appropriately assigned to respond to these events (see, for example, U.S. Pat. No. 6,383,077 to Kweitko et al., which is hereby incorporated by reference). However, such systems heretofore have not provided a means, for example, for distinguishing key service events and managing limited service provider resources to give priority to servicing key service events.

### SUMMARY OF THE INVENTION

These and other limitations of the prior art are overcome by a novel method and system for assigning a service provider to service an event or action associated with a gaming activity. In a first embodiment, the method of the present invention comprises the steps of a) identifying one or more service events, b) determining an event qualification including at least one of a gaming activity type, a customer identifier, an event type, an event location and an event open time for each of the identified service events, c) determining a highest-priority event based on a predetermined set of rules and the event qualification for each identified event, d) identifying one or more available service providers, and e) selecting an available service provider to service the highest-priority event.

In a second embodiment, the method of the present invention additionally comprises the steps of f) determining a service provider qualification including at least one of a current assignment indicator, a current location, an occupancy indicator, a skills/experience indicator and a service rate for each available service provider, and g) selecting the selected service provider based on the predetermined set of rules, the event qualification for the highest priority event and the service provider qualifications for the available service providers.

Preferably, the method of the present invention identifies a service distinction identifier for each customer, where the service distinction identifier provides an indication of customer priority. Preferably, the method also includes a step of determining an event status based on the predetermined set of rules and the event qualification.

In a third embodiment, the present invention further includes a system for assigning a service provider to service an event or action associated with a gaming activity. The system comprises a central processor having stored program control, an input port for receiving data, and a data store for storing received data, wherein the data store includes an event queue, a rules database and a service provider database. The central processor operates to a) receive data at the input port, b) store received data in the data store, c) retrieve stored data stored as one or more event records from the event queue, each event record identifying an event qualification including at least one of a gaming activity type, a customer identifier, an event type, an event location and an event open time, d) determine a highest priority event based on the one or more event records and on rules stored in the rules database, and e) determine whether there is at least one available service provider identified in the service provider database.

Preferably, the system further comprises one or more input/output devices, and the central processor is operable to f) determine an event status for each event based on the rules in the rules database and the event qualification for each event, and g) display the status of each event on at least one of the one or more input/output devices. In addition, at least one of the one or more input/output devices is operable to notify an available service provider of an assignment to the highest-priority service event.

### BRIEF DESCRIPTION OF THE DRAWINGS

A more complete understanding of the invention may be obtained by reading the following description of specific illustrative embodiments of the invention in conjunction with the appended drawing in which:

FIG. 1 presents a block diagram illustrating a service management system embodying principles of the present invention;

FIG. 2 provides a flow diagram showing a set-up process for the service management system of FIG. 1;

FIGS. 3-5 provide sample computer-based forms that illustrate means for carrying out elements of the set-up process of FIG. 2;

FIG. 6 lists sample rules for defining service event priorities in accordance with principles of the present invention;

FIG. 7 provides a flow diagram showing an operations process for the service management system of FIG. 1;

FIGS. 8-10 provide sample computer-based forms that illustrate means for carrying out elements of the process of FIG. 7; and

FIGS. 11a-d provide sample reports provided in support of the process of FIG. 7.

### DETAILED DESCRIPTION OF THE PREFERRED EMBODIMENTS

The following detailed description includes a description of the best mode or modes of the invention presently contemplated. Such description is not intended to be understood in a limiting sense, but to be an example of the invention presented solely for illustration thereof, and by reference to which in connection with the following description and the accompanying drawing one skilled in the art may be advised of the advantages and construction of the invention. An existing embodiment of the present invention is described with reference to servicing gaming machines. It will be understood, however, by one skilled in the art that the present invention is easily applied to the servicing of a variety of other gaming activities as well.

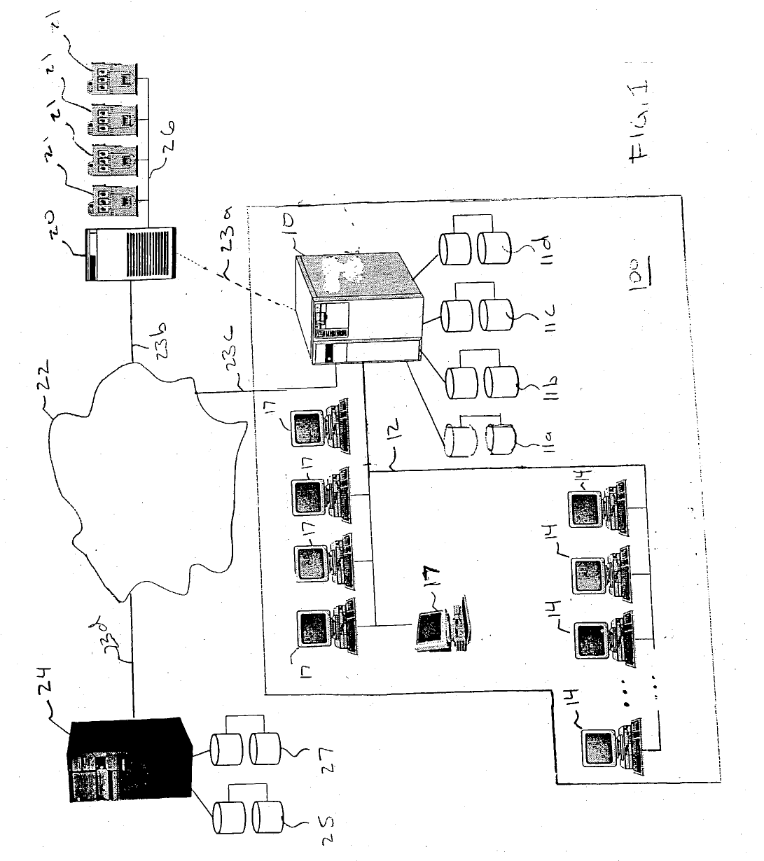

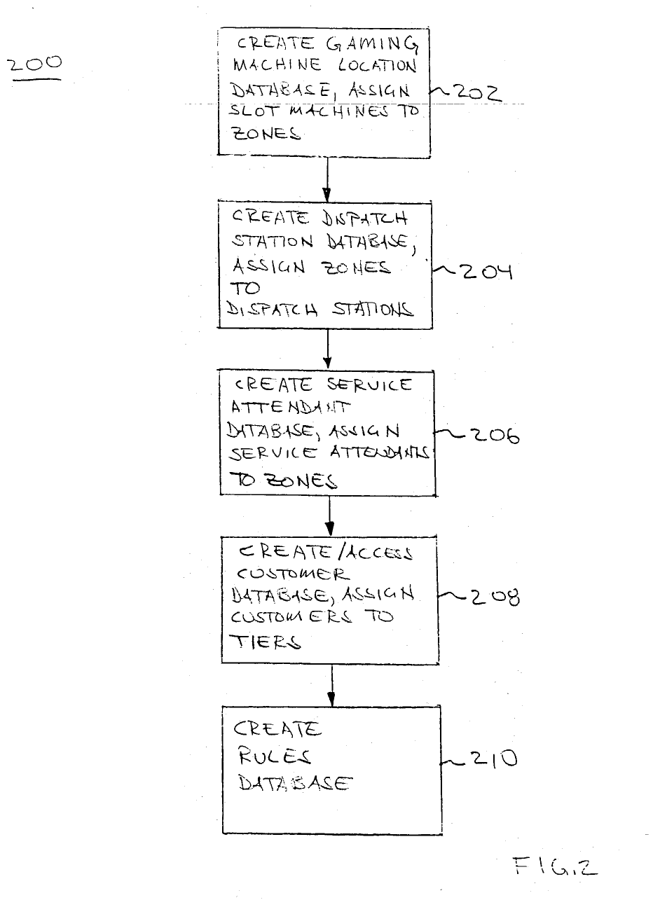

FIG. 1 provides a block diagram illustrating a real-time service management (RTSS) system 100 embodying principles of the present invention. RTSS system 100 may be connected, for example, via wide area network 22 to receive information from one or more information systems already in use in a gaming activity environment such as a casino or casino network.

For example, as illustrated in FIG. 1, RTSS system 100 receives information from event server 20 either over a direct interconnection 23a, or via a link 23b to wide area network 22 and thereafter via link 23c. Automated gaming machines 21 (for example, slot machines) are configured to submit machine event data to be stored by event server 20, for example, over local area network 26. Local area network 26 may be implemented, for example, as a wireless local area network in order to provide for flexible location of machines 21 (see, e.g., previously-referenced U.S. Pat. No. 6,383,077).

Event server 20 forwards stored machine event data to RTSS server 10 in RTSS system 100. Event data may include, for example, data providing a gaming activity identifier (e.g., slot machine serial number), event type (e.g., coin-in jam), event location (e.g., a designated zone on the gaming floor), an event open time (e.g., 13:42:37), customer identification information (e.g., customer JONES, service distinction level PLATINUM), and service provider identification information (e.g., service attendant SMITH, employee number 12345).

Customer identification information and service provider identification information relating to service events may be obtained, for example, by requiring customers and service providers to insert machine-readable identification cards at a subject gaming machine in order to access gaming and/or service features. Alternatively, a service provider might for example use a wireless personal digital assistant, or other similar communications device, with means for identifying a machine being serviced (for example, such as a bar code reader) in order to provide this information. Features of event server 20 may alternatively be embodied in RTSS server 10 for gaming environments that lack current means for collecting machine event data.

As illustrated in FIG. 1, RTSS system 100 may retrieve information in real-time via links 23c, d and wide area network 22 from gaming environment server 24, which may be used for example to store information about active gaming machine service providers in database 25, and to store information about active gaming activity environment customers in database 27. For environments that lack such means, features of server 24 and databases 25, 27 may also alternatively be embodied in RTSS server 10.

RTSS server 10 comprises a processor with stored program control including a conventional operating system (for example, MS WINDOWS 2000 or the equivalent), a conventional database management system (for example, MS SQL SERVER 2000 or the equivalent), and application software for operating RTSS server 10. Operation of RTSS server 10 is further described herein.

RTSS server 10 processes service provider, customer and machine service event data provided by servers 20, 24, for example, to form machine and management station location database 11a, service provider database 11b, rules database 11c and event log 11d. Machine and management station location database 11a is used to make record of each of the gaming machines to be attended to, their locations, and their assignment to one or more management stations 17. In large gaming environments, for example, groups of gaming machines may be organized into multiple zones each having a dedicated management service station in order to provide for prompt and efficient service.

Service provider database 11b is used to make record of service provider staff, including, for exampleassignment to zones, general status (for example, active, inactive), specific status (assigned, on break, unassigned), and access information (for example, email address, paging address, cell phone number, or the like). Service provider data may be provided, for example, to RTSS server 10 by service providers at service provider workstations 14 or by gaming activity environment managers at manager workstations 17, and then forwarded to server 24 for storage in database 25. General service provider status information may alternatively be provided, for example, from conventional time clock and badge entry systems that may currently be deployed within gaming activityenvironments.

Rules database 11c contains predetermined rules by which gaming activity environment managers may determine highest priority service events for response. Rules are determined in accordance with operating policies and goals of the gaming environment provider, and may include, for example, objective times for responding to and resolving service events based on event type and customer service distinction identifier.

Event log 11d records service events for each gaming machine or gaming activity. For each event, such data may include, for example, associated machine location (zone) and management station information, time at which a service event is reported (open time), customer identification (for example, customer name, customer number, service distinction identifier or other identifier), priority of service event, assigned service provider identifier, time at which service provider was assigned, time at which service response started, and time of service response completion.

Service provider workstations 14 and management workstations 17 are each connected to RTSS server 10, for example, via a conventional local area network 12. Manager workstations 17 may be used, for example, by a gaming activities environment manager to set-up RTSS system 100, and to monitor system performance.

For example, and as depicted in FIG. 2, set-up process 200 begins with the assignment of gaming machines to zones at step 202, and continues with the assignment of zones to management stations at step 204. The information produced at steps 202, 204 is then used to form machine and management station location database 11a. Zones may typically be established in large gaming activity environments where it may be efficient to assign one or more service providers exclusively to service machines in that zone, and one or more managers each to exclusively manage and assign service providers within one or more zones. It should be noted that the present invention is also operable in gaming environments that do not define such zones (for example, by assigning all machines in machine and management station location database 11a to a single zone).

At step 206, service providers are identified and assigned to zones in order to create service provider database 11b. At step 208, customers are identified and assigned to service distinction identifiers to form, for example, customer database 27. And at step 210, service rules are specified to be included in rules database 11c.

With respect to steps 202-204 and 210, application software in RTSS server 10 may preferably be configured to provide form-based templates at manager workstation 17 for entry of the associated data. Such forms are optionally provided for data entry in accordance with steps 206 and 208, which may alternatively at least in part be accomplished by existing applications resident, for example, on one or more of servers 20, 24. For example, because service distinction identifiers may be assigned on the basis of levels of customer gaming activity, server 24, may be configured to continuously poll customer gaming activity data (transactions) in order to dynamically update service distinction or identifier assignments in real-time.

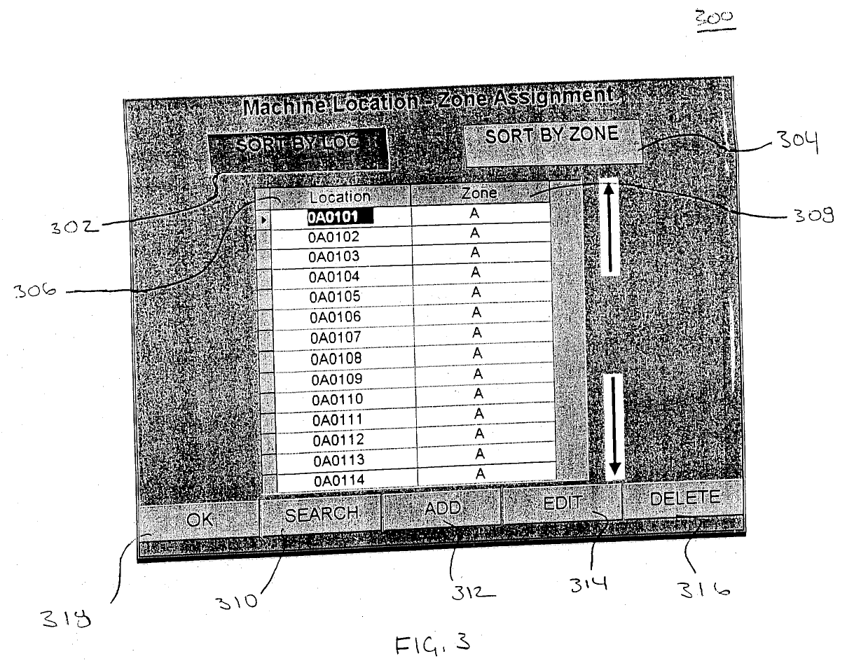

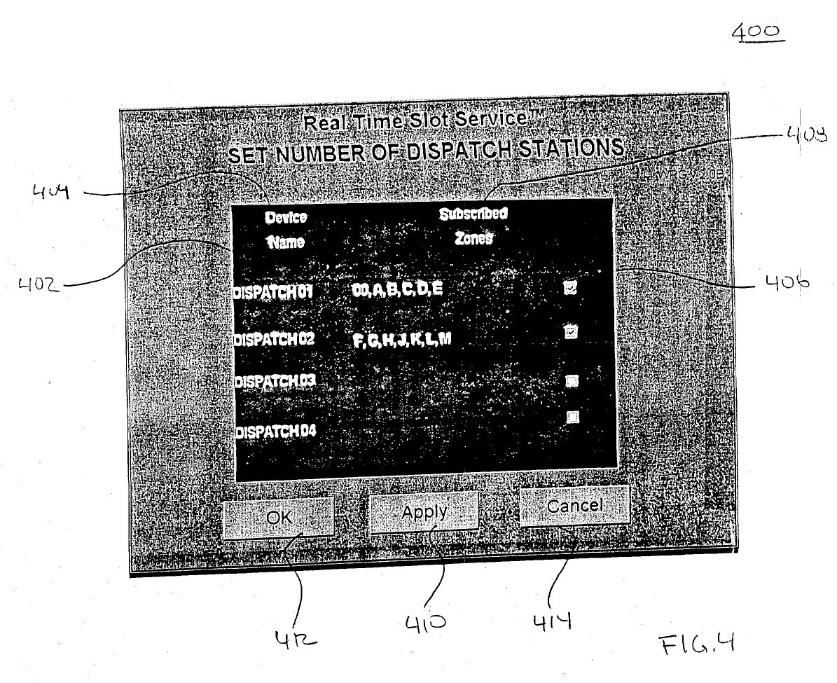

FIG. 3 provides an example of a form used in conjunction with step 202 of FIG. 2. The form illustrated by FIG. 3 (as well as other forms illustrated herein) may be preferably implemented to be displayed on one or more of service provider workstations 14, and manager workstations 17. These workstations are preferably configured to include conventional touch-screen input means or other conventional graphically oriented input means for users to select the features associated with the forms.

As illustrated in FIG. 3, Machine Location—Zone Assignment form 300 allows a gaming activity environment manager to review machine location and zone information in list form that can be sorted by location (button 302, field 306) or by zone (button 304, field 308). Search button 310 allows the manager to search for a specific value in either of fields 306, 308. Add button 312 allows new location/zone records to be selectively added, edit button 314 allows existing location/zone records to be selectively modified, and delete button 316 allows existing records to be selectively deleted. The manager may review any updates made via add button 312, edit button 314 and delete button 316 before selecting accept button 318 (“OK”) to save updates to machine and management station location database 11a.

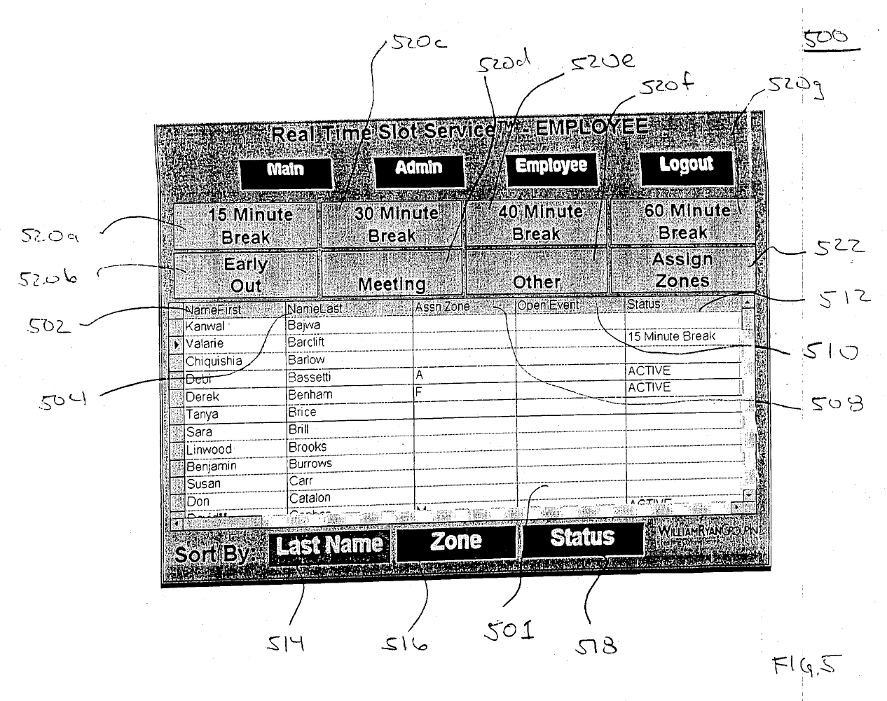

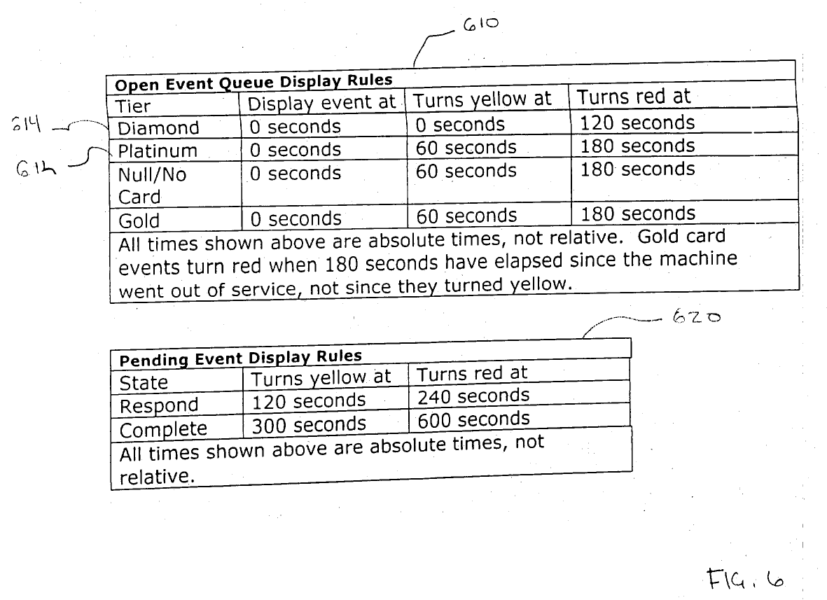

FIG. 4 provides an example of a form used in conjunction with step 204 of FIG. 2. Dispatch station assignment form 400 provides a screen 402 for entering management station and related gaming machine zone information. Available management stations are listed in Device Name column 404. Each available station is marked as active (check) or inactive (no check) in an associated checkbox 406. Zones assigned to each active station are listed in Subscribed Zones column 408. Changes entered to columns 404, 408 and checkboxes 406 may be saved to machine and management station location database 11a by selecting apply button 410 followed by accept button 412 (“OK”), or may alternatively be discarded by selecting cancel button 414.

FIG. 5 provides an example of a form illustrating data produced in step 206 of FIG. 2 with regard to employee service providers. Employee service provider form 500 provides a table 501 including column 502 listing employee first name, column 504 listing employee last name, column 508 listing one or more zones to which the employee is assigned, column 510 listing one or more events to which the employee is assigned, and column 512 indicating a current work status for the employee. Additional columns (not shown) may optionally be added, for example, to indicate additional employee status information, such as time in and time out.

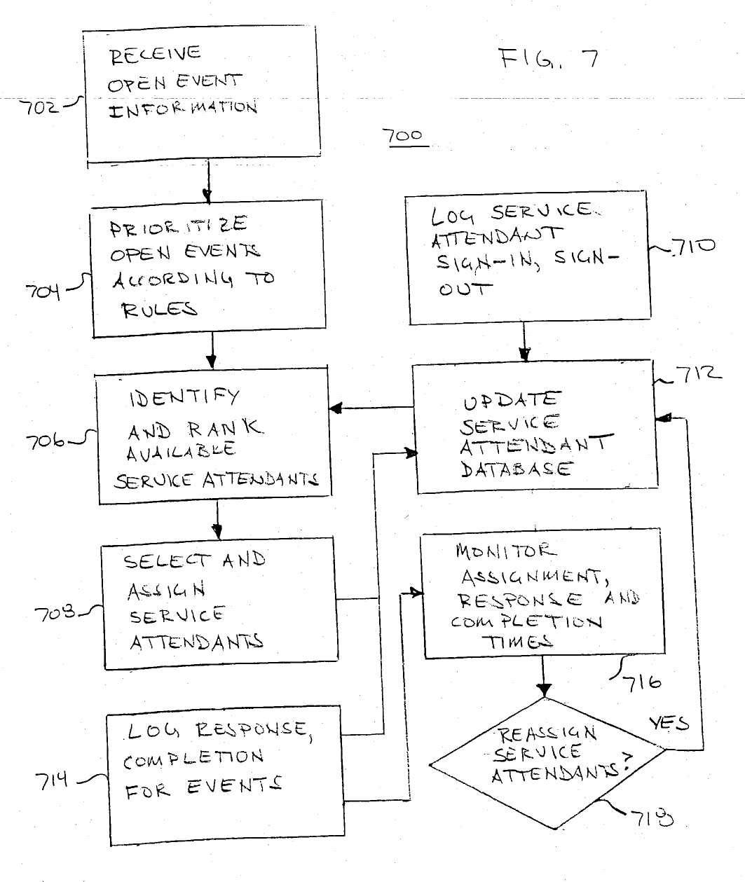

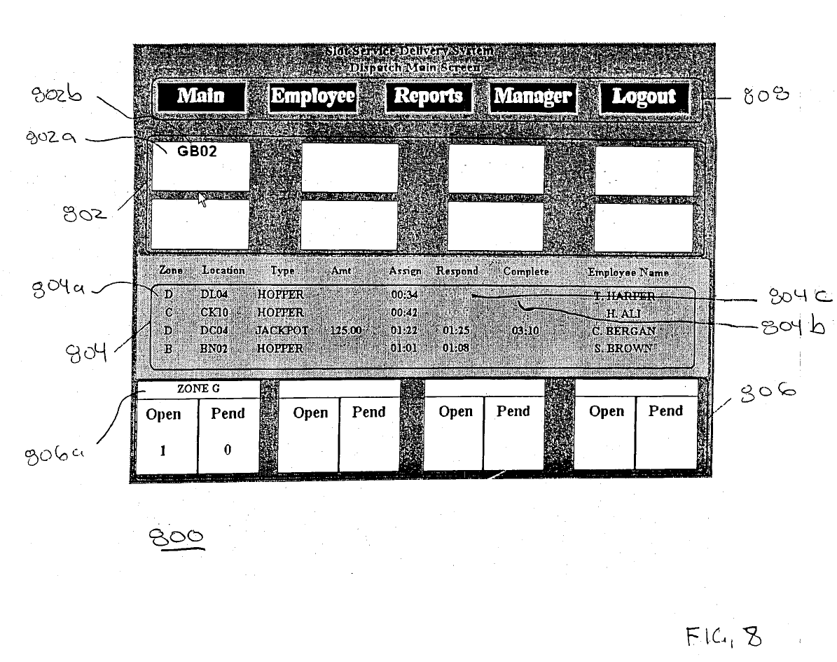

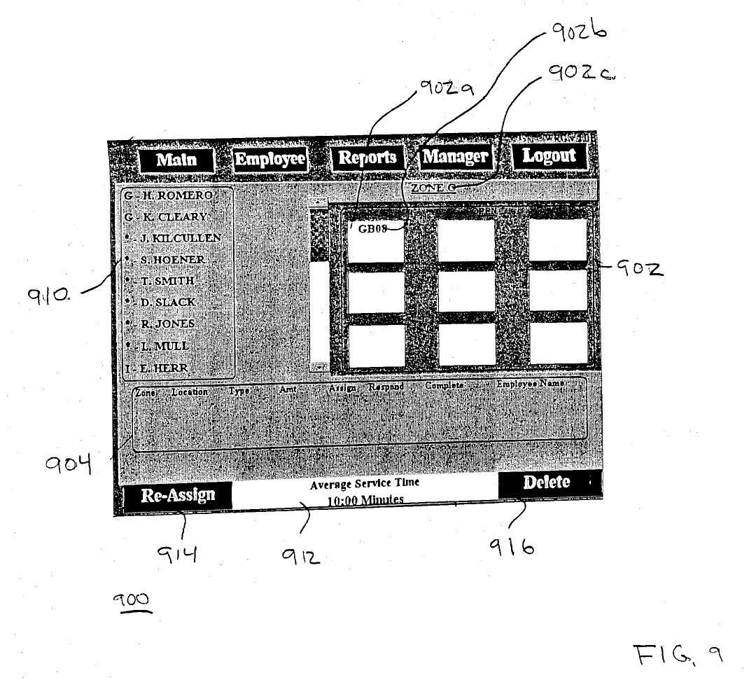

Selecting each of buttons 514, 516 and 518 causes data in the table 502 to be respectively sorted by employee service provider last name, location zone and current work status. Buttons 520a-g enable convenient entry of standard status indicators in column 512 (for example, break period indicators for a variety of break period lengths, signing in and signing out). Recording status changing events is preferably performed directly by service providers at service provider workstations 14, or via use of an alternate communications device (for example, by telephone-based audio response system, by wireless personal digital assistant or other wireless communications device, or by swiping a service provider badge at an appropriate provider identification station), and is highlighted at step 710 of operations process 700 of FIG. 7. Service provider status may alternatively be recorded and updated by other personnel (for example by gaming activity environment managers).

Button 522 allows for dynamic assignment of employees to zones. Service provider assignments may be performed by the service providers themselves using the means described above, or alternatively by RTSS managers at management workstations 17.

FIG. 6 provides an example of service rules captured at step 210 of FIG. 2. Tables 610, 620 respectively list rules governing display of open event and pending event information at management workstations 17 of FIG. 1. As summarized in row 612 of table 610, for example, an open service event associated with a platinum customer is declared as being “yellow” (first alerting level) 60 seconds after the event opens, and declared as being “red” (critical alerting level) 180 seconds after the event opens. Before reaching either of the “yellow” or “red” levels, the event may be declared to be “green” (pre-alert level).

By contrast, as summarized in row 614 of table 610, an open service event associated with a highest-distinction or identifier customer (“diamond) is declared as being yellow when the event opens, and declared as being red 120 seconds after the event opens. Thus, in this case, there is effectively no pre-alert level. In addition, although not shown, the rules may be defined to be event-sensitive. For example, with reference to the higher service distinction (or “platinum”) customer of row 612, rules may be defined causing an open event to turn red at 180 seconds for a payout in excess of a current fill, and to turn red at 120 seconds for a coin jam. Additional rules may be defined in rules database 11c for establishing event priority. For example, such rules could prescribe a priority given first to all red events on the basis of elapsed time since event open time, and thereafter similarly to all yellow events. Alternatively, priority could be based on an elapsed time starting at various predetermined times after event open time, based on customer distinction level.

Once set-up process 200 of FIG. 2 has been completed, operations under RTSS system 100 of FIG. 1 may begin. FIG. 7 presents a flow diagram depicting operations process 700. At step 702, a service event is reported to RTSS system 100, for example, via event server 20 of FIG. 1. At step 704, the event is added to event log 11d, and prioritized with respect to other pending events in accordance with rules provided in rules database 11c. As a result of event prioritization, for example, managers may retrieve an event report at management workstations 17 listing uncompleted events in a priority order to be addressed.

At step 706, managers operate management workstations 17 to select an available service provider to respond to the prioritized events. Employee screen 500 of FIG. 5 may be used for this purpose, and may further include a variety of information to assist in the selection process, for example, including each service provider's primary gaming machine zone responsibilities (column 508 of FIG. 5), current availability, time since attending a last service event (column 512), and indicator of specific skills and experiences relating to identified problem types (not shown). At step 708, managers proceed via management workstations 17 to select and assign service providers to specific service events. Upon completion of these assignments, service provider database 11b of FIG. 1 is updated at step 712 of FIG. 700 to reflect current service provider availability. As earlier described with reference to FIG. 5, other status-changing events (sign-in, sign-out and breaks) may be reported at step 710 to update service provider database 11b at step 712.

Via event server 20, for example, as indicated at step 714, RTSS server 10 periodically receives information (for example, indicating response to or completion of an event) to update event log 11d. At step 716, RTSS server 10 may use this information to report information about RTSS process performance including, for example, average event response and completion times. At step 718, decisions may be made on the basis of the reported performance information to reassign or add service providers, and/or to reschedule discretionary provider tasks (such as auxiliary hopper fills, meetings and the like) for time periods that appear to have relatively low service demands.

While steps 706, 708 of FIG. 7 have been described as being performed by managers, it should be understood that steps 706, 708 may alternatively be automatically performed by RTSS system 100 with the incorporation of appropriate associated rules in rules database 11c. For example, such rules might prescribe selecting and assigning an available service provider that is currently in a zone closest to the event zone, with ties (i.e., circumstances in which more than one available service provider is present in a closest zone) being broken by selecting the service provider having the longest time available since a prior service event. Once a service provider is selected and assigned, RTSS system 100 would communicate associated event information, for example, wirelessly to a pager or personal data assistant of the assigned service provider. A variety of other rules schemes and means for communicating with an assigned service provider are readily discernible to one skilled in the art, and contemplated within the scope of the present invention.

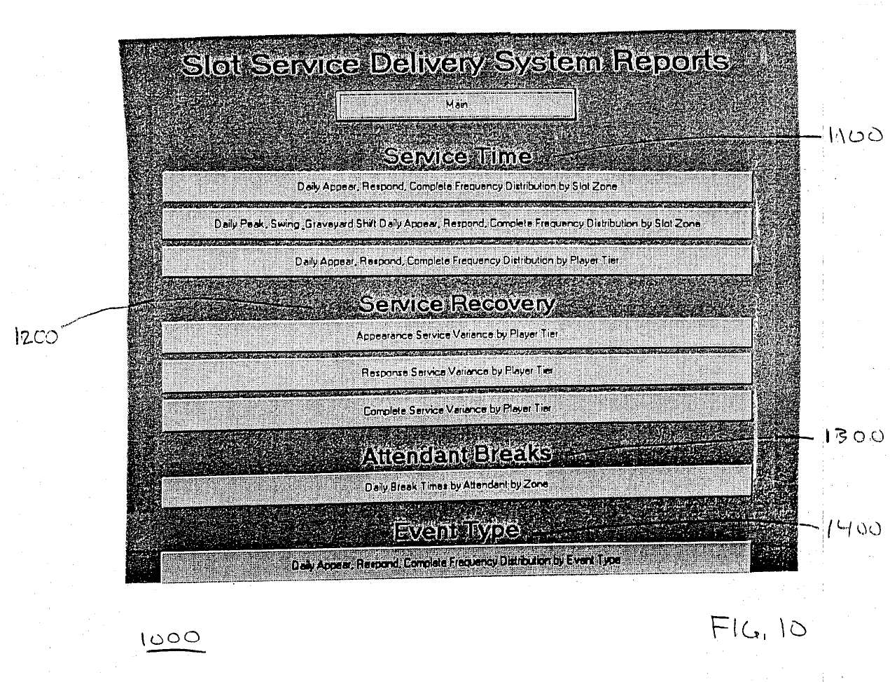

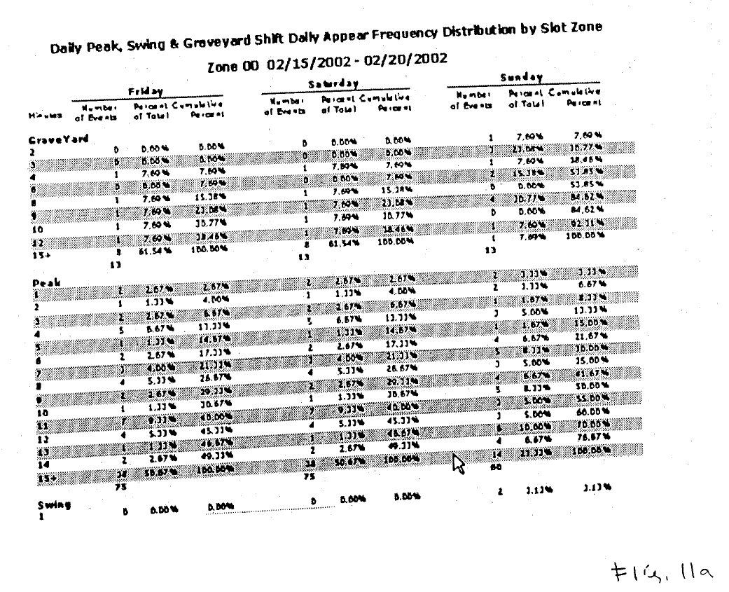

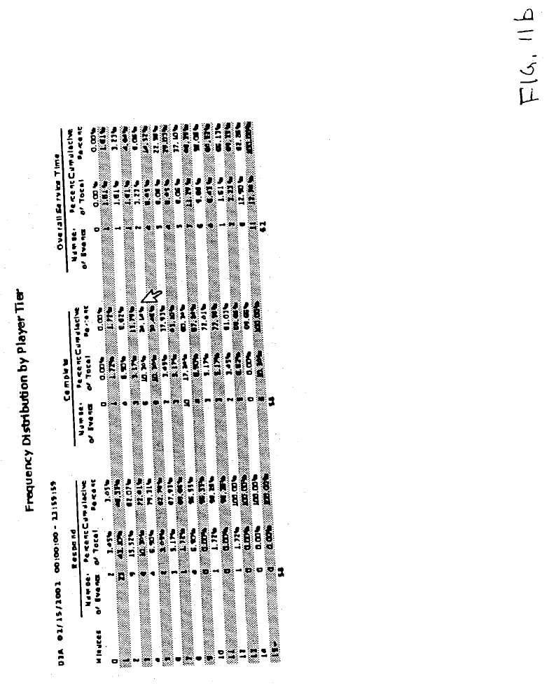

FIGS. 8, 9 depict example forms to be used by a manager to perform steps 702, 704, 708, 716 and 718 of operations process 700 of FIG. 7. In FIG. 8, main screen 800 includes an open events queue 802 for listing open service events that have yet to be assigned to a service provider. Each box 802a identifying an open event 802b may, for example, be portrayed in a color indicative of status as described with references to tables 610, 620 of FIG. 6 (for example, to portray yellow or red status). Queue 802 may be arranged, for example, to order open events by priority (a highest priority event is positioned, for example, as uppermost and leftmost box 802a of region 802).

Pending events list 804 lists information pertaining to pending events that have been assigned, but not completed. For example, first row 804a of events list 804 indicates by virtue of blank cell 804b that the event associated with first row 804a has yet to be completed. Cell 804c reports a response time for the event of row 804a, but indicates by color that the response came at a time when the event was classified as having yellow status.

Zone scoreboard 806 indicates the number of events currently either open or pending in each of the zones managed by a manager, For example, box 806a reports 1 open and no pending events in zone G. Navigation buttons 808 enable the manager to access other forms and features of RTSS system 100.

Open events queue 802, pending events list 804 and zone scoreboard 806 of management main screen 800 provide a collective information set (“instrument panel”) by which a manager can determine overall service performance in each service zone for which the manager has responsibility. If main screen 800 indicates that performance may be inadequate (for example, by showing a significant number of open or pending events having yellow or red status), the manager may take action to obtain additional service providers to close open items and/or to assist or replace assigned staff currently working on pending items.

In FIG. 9, assignment form 900 provides an ordered service providers list 910 listing service providers assigned to selected zone G (902c), assigned to zones adjacent to zone G, or otherwise assigned as “floaters”. As illustrated in FIG. 9, list 910 shows names of service providers preceded either by an alpha character indicating assigned zone, or an asterisk indicating “floaters”.

Service providers listed in list 910 may be listed in a priority order in accordance with rules defined in rules database 11c of FIG. 1. For example, and as shown in list 910 of FIG. 9, highest priority is given to service providers assigned to the selected zone 902c, and among that group, to those service providers who have been waiting longest for assignment. In descending order, priority is next given to “floating” service providers, then to service providers in other zones handled by the current manager, and then to service providers in other zones handled by other managers. It should be noted that, as an alternative to the illustrated zone-based approach for prioritizing service providers with regard to their proximity to a device to be serviced, service providers could be outfitted, for example, with location-measuring activities (such as a conventional global positioning system receiver integrated with a wireless personal digital assistant communications device) for more direct measurement of proximity of providers to the device to be serviced.

As shown in FIG. 9, RTSS system 100 provides the manager with an average service time statistic 912 for selected zone 902c, and allows the manager to assign a service provider from list 910 to an open event 902b, for example, by clicking on open event 902b to select it, clicking on a service provider name in list 910 to select the named service provider, and clicking on the open event 902b once again to confirm the assignment. Once assigned, the event will move from open event queue 902 to pending event queue 904.

In order to reassign an event, for example, the manager clicks on the row indicating the pending event in queue 904, clicks on reassign button 914, and then clicks on the pending event row in queue 904 to confirm the reassignment. Once confirmed, the previously assigned service provider returns to list 910, and the event returns to open event queue 901. A new service provider may then be assigned following the open event assignment procedure outlined above. Alternatively, the event may remain in pending queue 904, and an additional service provider may be assigned using an analogous procedure. The manager may abort a service event by selecting the open event in queue 902 or the pending event row in pending queue 904 and then clicking on delete button 916.

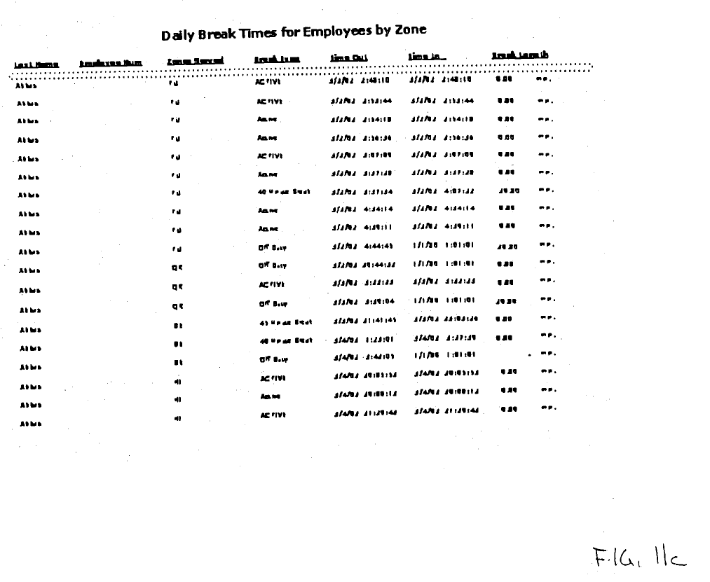

RTSS system 100 optionally provides analysis and reporting capabilities for information stored in machine and management station location database 11a, service provider database 11b, rules database 11c and event log 11d. These capabilities are preferably implemented in application software residing on one or more of RTSS server 10 and manager workstations 17, and based on a conventional database management system engine such as MS SQL SERVER 2000 or the like. FIG. 10 illustrates a sample reports form 1000 to be accessed, for example, by manager workstation 17. As illustrated in FIG. 10, reports form 1000 provides access to four categories of reports for RTSS system 100. Service time reports (1100) may be accessed to provide daily distributions of event appearance, service response and completion times segmented by service zone, service provider shift and customer distinction or identifier. Service Recovery reports (1200) detail response and completion times by event, sorted by player distinction or identifier. Service Provider (Attendant) Break reports (1300) report daily break times and lengths for service providers in order to determine service provider availability and utilization. Event Type reports (1400) provide daily distributions of event appearance, service response and completion times segmented by event type.

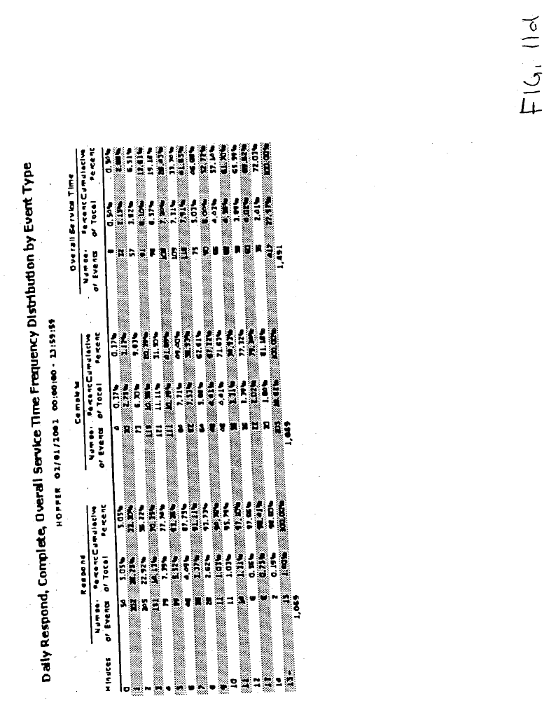

FIGS. 11a-d provide examples of reports accessed via reports form 1000. FIG. 11a lists daily distributions of event appearance times segmented by service provider shift (three example shifts are shown as “graveyard,” “peak” and “swing”) for a single zone and a three-day window. FIG. 11b lists a daily distribution of response, completion and overall service times for “diamond” distinction or identifier customers. FIG. 11c lists daily breaks by time out and length for each service provider. FIG. 11d lists daily service response and completion time distributions segmented by event type (an example is shown for “hopper fill”). It will be readily recognized by one skilled in the art that FIGS. 10, 11a-d represent but a few examples of many reports contemplated by the present invention that may easily be generated to accumulate and correlate information regarding gaming environment customers, service providers and service events.

While the examples provided to this point to illustrate the principles of the present invention were largely selected with reference to automated gaming machines, one skilled in the art will readily recognize the applicability of the present invention to other gaming activities, and in particular, to other gaming activities for which event and customer data can be collected electronically and in real-time.

For example, consider an application of the present application directed to one or more cocktail lounges in a casino. In this example, a restaurant manager seeks to effectively manage a staff of waiters and waitresses (service providers) in order to provide a high service quality for important customers seeking visiting the lounge. Consider, for example, the following scenario.

A customer enter a lounge, self-seats herself at an available table, and requests service by swiping, for example, a customer identification card through an electronic card reader installed in the table. At this point, the customer identifier is provided to RTSS server 10 of FIG. 1 via server 20, an open event is registered in event log 11d, and a customer distinction identifier based on the customer identifier is retrieved from customer database 27 and forwarded to RTSS server 10 by server 24. The electronic card reader also forwards a table location identifier to RTSS server 10 via server 20. Based on event open time and on business rules stored in rules database 11c, RTSS serve 10 reports the service request event at manager workstation 17, and indicates that the event has a status of red and highest priority among currently open service requests.

The restaurant manager queries database 11b to find an available waitress in closest proximity to the table location, and forwards a dispatch message to the waitress' pager, with a service order authorization identifying the table number. The waitress reaches the table, and swipes her employee identification card through the card reader in order to update the event log 11d to indicate that the state of the event is pending. She then takes the customer's order, and returns to deliver the order to the customer shortly thereafter. She again swipes her employee identification card through the card reader in order to update the event log 11d to indicate that the state of the event is closed. A similar sequence of events may be easily envisioned for each of the variety of service activities found in a gaming activity environment.

The foregoing describes the invention in terms of embodiments foreseen by the inventor for which an enabling description was available, notwithstanding that insubstantial modifications of the invention, not presently foreseen, may nonetheless represent equivalents thereto.

What is claimed:

1. A method for assigning a service provider to service an event associated with a gaming activity, the method comprising the steps of:
identifying one or more open service events;
determining an event qualification including at least one of a gaming activity identifier, a customer identifier, an event type, an event location and an event open time for each of the identified service events;
determining a highest priority event among the one or more open events based on a predetermined set of rules and the event qualification for each of the one or more open events;
identifying one or more available service providers; and
selecting a service provider from among the one or more available service providers for servicing the highest priority event.

2. The method of claim 1, prior to the step of selecting a service provider, further comprising the step of:
determining a service provider qualification including at least one of a current assignment indicator, a current location, an occupancy indicator, a skills/experience indicator, and a service rate for each available service provider.

3. The method of claim 2, wherein the selected service provider is selected based on the predetermined set of rules, the event qualification for the highest priority event and the service provider qualifications for the available service providers.

4. The method of claim 1, wherein the gaming activity includes the operation of at least one of a plurality of slot machines, a plurality of video lottery machines and a plurality of gaming tables.

5. The method of claim 1, wherein the event qualification includes a customer service distinction identifier.

6. The method of claim 1, wherein at least one of the one or more service events and one or more available service providers are identified in real-time.

7. The method of claim 1, wherein the highest priority event is determined in real-time.

8. A method for assigning a service provider to service an event associated with a gaming activity, the method comprising the steps of:
identifying one or more pending service events;
determining an event qualification including at least one of a gaming activity identifier, a customer identifier, an event type, an event location and an event arrival time for each of the identified service events;
determining a highest priority event among the one or more pending events based on a predetermined set of rules and the event qualification for each of the one or more open events;
identifying one or more available service providers; and
selecting a service provider from among the one or more available service providers for servicing the highest priority event.

9. The method of claim 8, prior to the step of selecting a service provider, further comprising the step of:
determining a service provider qualification including at least one of a current assignment indicator, a current location, an occupancy indicator, a skills/experience indicator, and a service rate for each available service provider.

10. The method of claim 8, wherein the selected service provider is selected based on the predetermined set of rules, the event qualification for the highest priority event and the service provider qualifications for the available service providers.

11. The method of claim 8, further comprising the step of:
releasing a formerly-assigned service provider from the highest-priority pending event after assigning the selected service provider.

12. The method of claim 8, wherein the gaming activity includes the operation of at least one of a plurality of slot machines, a plurality of video lottery machines and a plurality of gaming tables.

13. The method of claim 8, wherein the event qualification includes a customer service distinction identifier.

14. The method of claim 8 wherein at least one of the one or more service events and one or more available service providers are identified in real-time.

15. The method of claim 8, wherein the highest priority event is determined in real-time.

16. The method of claim 1, further comprising the step of determining an event status based on the predetermined set of rules and the event qualification.

17. The method of claim 8, further comprising the step of determining an event status based on the predetermined set of rules and the event qualification.

18. The method of claim 16, further comprising the step of reporting the event status as one of a pre-alert level, a first alert level and a critical alert level.

19. The method of claim 17, further comprising the step of reporting the event status as one of a pre-alert level, a first alert level and a critical alert level.

20. A system for assigning a service provider to service an event associated with a gaming activity, the system comprising:
a central processor having stored program control;
an input port for receiving data; and
a data store for storing received data, the data store including an event queue, a rules database and a service provider database;
wherein the central processor is operable to:
receive data at the input port;
store received data in the data store;
retrieve stored data stored as one or more event records from the event queue, each event record identifying an event qualification including at least one of a gaming activity identifier, a customer identifier, an event type, an event location and an event open time;
determine a highest priority event based on the one or more event records and on rules stored in the rules database; and
determine whether there is at least one available service provider identified in the service provider database.

21. The system of claim 20, further comprising one or more input/output devices for communicating with the central processor.

22. The system of claim 21, wherein the at least one of the one of more input output devices is selected from the group consisting of personal computers, engineering workstations, telecommunications terminals, personal communications devices and personal digital assistants.

23. The system of claim 21, wherein each event record further identifies an event state, each event state having a value selected from the group consisting of open, pending and closed.

24. The system of claim 21, wherein the central processor is further operative to:
assign one of the one or more available service providers to service the highest priority event.

25. The system of claim 24, wherein the central processor is further operative to store an assignment indicator for the assigned service provider in the service provider database.

26. The system of claim 24, wherein the central processor is further operative to:
release a service provider previously assigned to the highest priority event by modifying an assignment indicator in the service provider database for the previously assigned service provider.

27. The system of claim 24, wherein the central processor is further operative to:
notify the assigned service provider via the one or more input/output devices.

28. The system of claim 20, wherein the central processor is further operable to determine an event status for each event based on rules in the rules database and the event qualification for each event.

29. The system of claim 28, wherein the event status for each event is determined to have a value reflecting one of a pre-alert level, a first alert level and a critical alert level.

30. The system of claim 21, wherein at least one of the one or more input/output devices include a graphical display, and the central processor is further operable to cause event status to be visually displayed on the graphical display, wherein a status for a pre-alert event displays a green coloring, a status for a first alert level event displays a yellow coloring, and a status for a critical event displays a red coloring.

31. The system of claim 21, wherein the central processor is further operative to:
prepare and display one or more data reports under the direction of the stored program control for output at the one or more input/output devices.

32. The system of claim 31, wherein the one or more data reports are selected from the group consisting of service time reports, service recovery reports, service provider break reports and event type reports.
